(19) United States
(12) Patent Application Publication
(10) Pub. No.: US 2013/0154812 A1
(43) Pub. Date: Jun. 20, 2013

(54) APPARATUS, SYSTEMS AND METHODS FOR COMMUNICATING REMOTE CONTROL INSTRUCTIONS

(71) Applicant: EchoStar Technologies L.L.C., Englewood, CO (US)

(72) Inventor: Jon Richardson, Chamblee, GA (US)

(73) Assignee: ECHOSTAR TECHNOLOGIES L.L.C., Englewood, CO (US)

(21) Appl. No.: 13/715,464

(22) Filed: Dec. 14, 2012

Related U.S. Application Data
(60) Provisional application No. 61/570,470, filed on Dec. 14, 2011.

(51) Int. Cl. G08C 19/00

(52) U.S. Cl. CPC G08C 19/00
USPC 340/12.52

(57) ABSTRACT

An exemplary electronic device receives control information via a wireless signal from a remote control, the control information configured to control operation of a target electronic device, and determines whether the target electronic device is configured to receive Consumer Electronic Control (CEC) format control information or receive non-CEC format control information. When the target electronic device is configured to receive CEC format control information, the received control information is translated into CEC format control information that the target electronic device is configured to interpret, and the translated CEC format control information is communicated to the target electronic device over a high-definition multimedia (HDMI) connector using the CEC format. When the target electronic device is not configured to receive CEC format control information, the received control information is translated into non-CEC format control information that the target electronic device is configured to interpret.

### PRIORITY CLAIM

This application claims the benefit of and priority to co-pending U.S. provisional application entitled “APPARATUS, SYSTEMS AND METHODS FOR COMMUNICATING REMOTE CONTROL INSTRUCTIONS,” having application Ser. No. 61/570,470, filed Dec. 14, 2011, and which is incorporated herein by reference in its entirety.

### BACKGROUND

Media devices, such as a set top box, a stereo, a television, a computer system, a game system, or the like, are often configured to receive operating instructions from a user via a remote control. The remote control communicates user instructions or commands to the media device using wireless signal, such as a radio frequency (RF) or an infrared (IR) signal.

Often, the remote control may be configured to operate with different types of media devices when an identifier of each controlled media device is known by the remote control. When the remote control is transmitting a wireless signal to the known target controlled media device, the wireless signal can be communicated in a format that the target controlled media device may receive. Accordingly, the target controlled media device may interpret the commands in the received wireless signal.

However, not all media devices may be controllable by the remote control. For example, the remote control may not be configured to control multiple devices. If the media device of interest is newer than the remote control, the remote control may not be able to interpret or recognize the identifier code of the media device of interest. Or, the number of media devices may exceed the number of controlled media devices that the remote control may be configured to control.

Accordingly, there is a need in the arts to provide alternative ways for a remote control to control different media devices of interest.

### SUMMARY

Systems and methods are operable to provide remote control generated information to a target electronic device. An exemplary electronic device receives control information via a wireless signal from a remote control, the control information configured to control operation of a target electronic device, and determines whether the target electronic device is configured to receive Consumer Electronic Control (CEC) format control information or receive non-CEC format control information. When the target electronic device is configured to receive CEC format control information, the received control information is translated into CEC format control information that the target electronic device is configured to interpret, and the translated CEC format control information is communicated to the target electronic device over a high-definition multimedia (HDMI) connector using a CEC format. When the target electronic device is not configured to receive CEC format control information, the received control information is translated into non-CEC format control information that the target electronic device is configured to interpret, which is then communicated to the target electronic device.

### BRIEF DESCRIPTION OF THE DRAWINGS

Preferred and alternative embodiments are described in detail below with reference to the following drawings:

FIG. 1 is a block diagram of an embodiment of a remote control communication proxy system implemented in a Consumer Electronic Control (CEC) proxy device;

FIG. 2 is a block diagram of an embodiment of a remote control communication proxy system implemented in a media device and implemented in a remote control;

FIG. 3 conceptually illustrates example information stored in the control information region of a memory medium; and

FIG. 4 is an example flow chart conceptually illustrating operation of an embodiment of the CEC proxy device.

### DETAILED DESCRIPTION

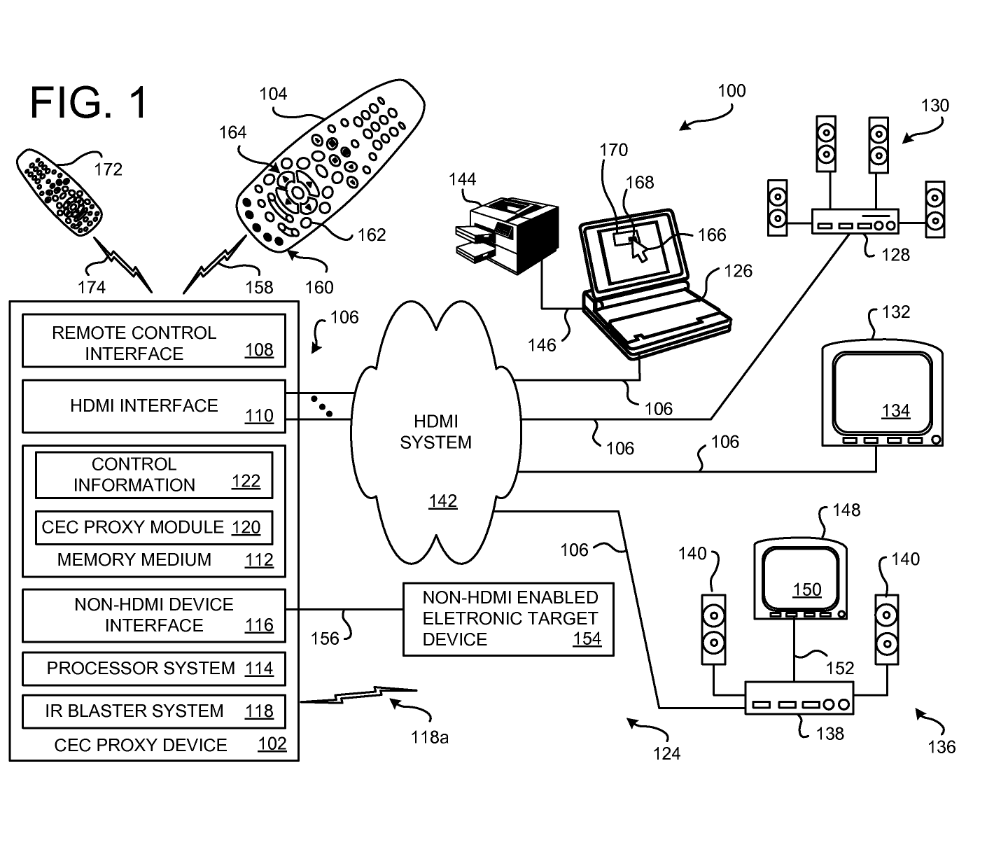

FIG. 1 is a block diagram of an embodiment of a remote control communication proxy system 100 implemented in a Consumer Electronic Control (CEC) proxy device 102. The example CEC proxy device 102 is high-definition multimedia (HDMI) enabled and is CEC enabled. Exemplary embodiments of the CEC proxy device 102 may be configured to receive control information from a remote control 104 to control operation of a target electronic device that is CEC enabled or that is not CEC enabled.

Example CEC formats are defined in various HDMI specification documents. For example, but not limited to, the HDMI Specification v. 1.4b, released on May 28, 2009, specifies CEC formats, and is incorporated by reference herein in its entirety.

The phrase “target electronic device” as used herein denotes an electronic device that a user wishes to operate using the remote control 104. That is, instructions or commands initiated by the user operating the remote control 104 are intended to operate the “target electronic device” of interest.

When the remote control 104 communicates control information with at least one instruction or command that is intended to control operation of a target electronic device that is not CEC enabled, the CEC proxy device 102 is configured to translate the received control information received from the remote control 104 into a non-CEC type communication format with control information having at least one instruction or command that can be interpreted by the target electronic device. The translated non-CEC format control information may be communicated from the CEC proxy device 102 to the target electronic device via a wire-based link or a wireless link.

Alternatively, or additionally, if the target electronic device is CEC enabled, the CEC proxy device 102 is configured to translate the received control information received from the remote control 104 into a CEC type communication format with control information having at least one instruction or command that can be interpreted by the CEC enabled target electronic device. The translated CEC format control information may be communicated from the CEC proxy device 102 to the target electronic device via HDMI connector 106.

The exemplary CEC proxy device 102 comprises a remote control interface 108, an HDMI interface 110, a memory medium 112, a processor system 114, an optional non-HDMI interface 116, and an optional infrared (IR) blaster system 118. The memory medium 112 may include a region for storing the CEC proxy module 120 and the control information 122 along with other regions that have logic or data that is related to operation of the CEC proxy device 102. Information used for translation of the control information received from the remote control 104 may be stored in any suitable format in the control information 122 region of the memory medium 112.

Alternative embodiments of the CEC proxy device 102 may include some, or may omit some, of the above-described components. Further, additional components not described herein may be included in alternative embodiments.

The IR blaster system 118 may comprise a plurality of other components (not shown) that enable the CEC proxy device 102 to transmit IR signals 118a out into a communication environment 124. In such embodiments, the IR blaster system 118 is configured to emulate an infrared remote control, such as the exemplary remote control 104, to autonomously control a target electronic device that is typically controlled by another remote control. Logic and components of the IR blaster system 118 are not described in greater detail herein other than to an extent necessary to describe operation of the remote control communication proxy system 100.

The example communication environment 124 includes at least one CEC proxy device 102, includes the example remote control 104, and includes a plurality of target electronic devices that may be controllable by control information communicated from the remote control 104. Under some operating conditions, one or more of the target electronic devices may be HDMI-CEC enabled target electronic devices that are configured to operate in accordance with CEC format control information received over a HDMI connector 106. Here, control information communicated from the remote control 104 is received by the CEC proxy device 102, and is then translated into CEC format control information. The translated CEC format control information is communicated from the CEC proxy device 102 to the HDMI-CEC enabled target electronic devices via the HDMI connector 106.

Under other operating conditions, one or more of the target electronic devices may be non-HDMI enabled, and thus non-CEC enabled, target electronic devices. These non-HDMI enabled target electronic devices are not configured to couple to a HDMI connector 106. However, they may have an IR detector (not shown) configured to receive IR signal 118a emitted by the IR blaster system 118 of the CEC proxy device 102. Here, control information communicated from the remote control 104 is received by the CEC proxy device 102, and is then translated into non-CEC format control information. The translated non-CEC format control information is communicated from the IR blaster system 118 to the non-HDMI enabled target electronic devices via IR signal 118a. The receiving non-HDMI enabled target electronic device then operates in accordance with the non-CEC format control information (the instructions and/or commands) in the received IR signal 118a.

Alternatively, some types of non-CEC enabled target electronic devices may be configured to receive control signals over an HDMI connector 106, referred to herein as HDMI enabled target electronic devices. Here, control information communicated from the remote control 104 is received by the CEC proxy device 102, and is then translated into non-CEC format control information. The translated non-CEC format control information is communicated from the CEC proxy device 102 to the HDMI enabled target electronic devices via the HDMI connector 106.

The exemplary CEC proxy device 102 is conceptually illustrated as a standalone device that is configured to communicatively couple to a HDMI system 104 employing one or more HDMI cables 106 that are CEC enabled. Alternatively, embodiments of the remote control communication proxy system 100 may be implemented in, or as a component of, other media devices such as, but not limited to, a set top box (STB), a stereo, a surround-sound receiver, a radio, a television (TV), a digital video disc (DVD) player, a digital video recorder (DVR), a game playing device, or a personal computer (PC) that is configured to receive communications from a remote control 104.

Examples of HDMI-CEC enabled target electronic devices include, but are not limited to, a personal computer 126 (conceptually illustrated as a laptop), a stereo system 128 that outputs audio content such as music through a plurality of speakers 130, a display device 132 (conceptually illustrated as a television) that presents video content on a display 134, and an entertainment system 136 comprising a surround-sound system 138 that outputs audio content on the speakers 140. These exemplary HDMI-CEC enabled target devices are configured to communicatively couple to other HDMI enabled devices using the HDMI connectors 106, generally illustrated as the HDMI system 142. Any one of the above-described example HDMI enabled devices and HDMI-CEC enabled target devices may be configured to operate in accordance with received CEC format control information received over a HDMI connector 106.

In the exemplary embodiment, the HDMI interface 110 of the CEC proxy device 102 is configured to communicatively couple to one or more HDMI connectors 106, thereby providing connectivity to a plurality of HDMI enabled target electronic devices and HDMI-CEC enabled target devices. Depending upon the configuration of the HDMI system 142, the CEC proxy device 102, the HDMI enabled target electronic devices, and the HDMI-CEC enabled target devices may be directly coupled to each other, may be coupled to each other via intermediary HDMI enabled devices, and/or may be coupled to a HDMI enabled communication bus (not shown) or the like. The CEC proxy device 102, the HDMI enabled target electronic devices, and the HDMI-CEC enabled target devices may be coupled in any suitable configuration that suites the operating conditions of the communication environment 124.

FIG. 1 also illustrates a plurality of non-HDMI enabled target electronic devices that may be controllable by the control information generated by and communicated from the remote control 104. Such exemplary non-HDMI enabled target electronic devices cannot be communicatively coupled to other devices using a HDMI connector 106. An example of a non-HDMI enabled target electronic device includes the example printer 144 that is illustrated as being communicatively coupled to the personal computer 126 via a uniform serial bus (USB) connector 146. Another example of a non-HDMI enabled target electronic device is the television 148 that is configured to present video on its display 150 that is received over an example coaxial cable 152 or the like communicatively coupled to the surround-sound system 138. Yet another example of a non-HDMI enabled target electronic device is a generic non-HDMI enabled target electronic device 154 that is illustrated as being communicatively coupled to the CEC proxy device 102 via a suitable wire-based connector 156. The non-HDMI enabled target electronic devices may be coupled in any suitable configuration that suites the operating conditions of the particular communication environment 124. Further, the various non-HDMI enabled target electronic devices may optionally include a wireless receiver (not shown) configured to receive a wireless signal, such as a radio frequency (RF) or an infrared (IR) signal.

The remote control 104 may be any type of remote control device. In the conceptual examples describing operation of the remote control communication proxy system 100, the remote control 104 is described and illustrated as communicating with the CEC proxy device 102 using wireless signal 158. The wireless signal 158 may be any suitable wireless signal, such as an RF or an IR signal, that is detectable by the remote control interface 108 of the CEC proxy device 102.

The exemplary remote control 104 is conceptually illustrated as a universal type remote control, which is a type of remote control that is configurable to operate a plurality of target electronic devices. To facilitate selection of a particular controllable target electronic device, a plurality of controllers 160, such as buttons or the like, are disposed on the surface of the example remote control 104. During some prior time, the remote control 104 is configured to associate with a particular controllable target electronic device. The association of a particular target electronic device may be effected in any suitable manner. Alternatively, the function of associating (selecting) a controllable target electronic device may be done on a displayable menu or other suitable graphical user interface (GUI).

During operation, the user selectively actuates one of the controllers 160 to associate with remote control 104 with a controllable target electronic device. Then, subsequent actuation of other controllers disposed on the surface of the remote control 104 results in generation of the control information that is intended to operate the controllable target electronic device.

For example, after a controllable target electronic device has been selected, another one of the controllers 162 disposed on the surface of the remote control 104 may be associated with a “power on” or a “power off” command. Accordingly, the controllable target electronic device will be powered on (if previously in a non-powered state) or will be powered off (if previously in a powered-on state) in response to actuation of the controller 162. As other non-limiting examples, a plurality of controllers 164 may be configured to cooperatively operate a displayed GUI, increase or decrease a volume level of output audio, and/or change channels of presented media content.

In instances where the target electronic device itself includes a wireless receiver (IR and/or RF) that is configured to receive the wireless signal 158 from the remote control 104, the target electronic device may operate in accordance with the control information in the directly-received wireless signal 158 (assuming that the target electronic device is configured to interpret the received control information transmitted by the remote control 104). However, in other instances, the target electronic device may not be able to interpret the received wireless signal 158 transmitted by the remote control 104. Or, the target electronic device may not be able to receive the transmitted wireless signal 158, such as when the target electronic device is out of reception range and/or if the wireless signal 158 is blocked by an object. Accordingly, embodiments of the CEC proxy device 102 facilitate control of the target electronic device when the target electronic device cannot receive and/or process the wireless signal 158 transmitted by the remote control 104.

In a first operation example, the user may wish to control the HDMI enabled stereo system 128. Accordingly, the user may actuate one of the controllers 160 on the remote control 104 to select the stereo system 128 as the target electronic device. Accordingly, subsequent actuation of controllers that generate the control information will be designated for control of the stereo system 128. For example, the user may actuate the controller 162 to power on the stereo system 128. The user, by next actuating the plurality of controllers 164, may select a radio station of interest for presentation of audio content, and/or may adjust output of the audio volume from the stereo system 128. The stereo system 128 in this simplified example is a HDMI enabled target electronic device that is also configured to receive and respond to CEC type commands. Accordingly, the CEC proxy device 102 provides CEC format commands to the stereo system 128 via the HDMI connector 106.

In some situations, the stereo system 128 may include a wireless signal receiver. Accordingly, the stereo system 128 may receive and operate in accordance with the wireless signal 118a transmitted from the IR blaster system 118 of the CEC proxy device 102. For example, the CEC proxy device 102 receives the wireless signal 158 from the remote control 104, recognizes that the stereo system 128 is the intended target electronic device, and then transmits the IR formatted non-CEC format control information signal 118a to the stereo system 128.

In a second operating example, the television 132 may be a type of HDMI enabled target electronic device that is not CEC enabled. That is, the television 132 is not configured to monitor the CEC conductor of its respective HDMI connector 106 for CEC type communications. When the user intends to operate the television 132, the user may actuate one of the controllers 160 on the remote control 104 that is associated with, and thus selects, the HDMI enabled television 132 as the intended target electronic device. Accordingly, subsequent actuation of controllers on the remote control 104 generate control information designated for control of the HDMI enabled television 132. However, the remote control 104 may not be configurable to generate the control information having the instructions or commands using the native format of the HDMI enabled television 132. That is, even if the HDMI enabled television 132 senses the wireless signal 158, the HDMI enabled television 132 will not respond.

In a first example scenario, the remote control 104 generates the control information that is transmitted in the wireless signal 158 to the CEC proxy device 102. Here, the processor system 114, executing the CEC proxy module 120, translates the control information received from the remote control 104 into corresponding native format instructions or commands that can be interpreted (understood) by the HDMI enabled television 132. The translation is based on a-priori information about the native format of the instructions or commands that can be interpreted by the HDMI enabled television 132. Information pertaining to the native format of the HDMI enabled television 132 may be obtained from any suitable source and/or may be stored in the control information 122. The translated control information is then communicated from the CEC proxy device 102 to the HDMI enabled television 132 via a suitable HDMI connector 106. (Alternatively, or additionally, the translated control information may be communicated from the CEC proxy device 102 to the HDMI enabled television 132 via the IR Blaster system 118.)

In some embodiments, the CEC proxy module 120 may be configured to track which of the various electronic devices are active. For example, the CEC proxy device 102 may transmit, either periodically or before receiving a command from the remote control 104, a query into the HDMI system 142 to query HDMI enabled electronic devices to ascertain their operating status (and/or the operating status of devices that they control). Accordingly, when a command from the remote control 104 is received by the CEC proxy device 102, the current target electronic devices are already identified. Accordingly, the CEC proxy device 102 may automatically determine if the command is to be sent to the target electronic device via the HDMI connector 106 or the IR blaster system 118 since the CEC proxy device 102 may also track whether a particular electronic device is CEC enabled, only HDMI enabled (non CEC enablement), or non-HDMI enabled.

In another operating example, the television 148 may be a type of non-HDMI enabled electronic device (or that is HDMI enabled, but is not currently coupled to one of the HDMI connectors 106). Here, the example television 148 is conceptually illustrated as being communicatively coupled to the surround-sound system 138 via a coaxial cable 152 (a non-HDMI type of wire connector). The surround-sound system 138 is configured to provide video and/or audio media to the television 148 via the coaxial cable 152. Presumably, the television 148 includes a detector configured to receive wireless signals, and in particular, the wireless signal 118a emitted by the IR blaster system 118.

When the user intends to operate the television 148, the user may actuate one of the controllers 160 on the remote control 104 to select the non-HDMI enabled television 148 as the intended target electronic device. Accordingly, subsequent actuation of controllers that generate the control information will be intended to control the non-HDMI enabled television 148. However, the remote control 104 may not be configured to generate the control information using the native format of the non-HDMI enabled television 148.

Here, the remote control 104 generates the control information using its own native format or another selected format. The processor system 114, executing the CEC proxy module 120, translates the control information received from the remote control 104 into corresponding native format instructions or commands for the non-HDMI enabled television 148. The translation is based on a-priori information about the native format of the instructions or commands that can be interpreted by the non-HDMI enabled television 148. Information pertaining to the native format of the non-HDMI enabled television 148 may be obtained from any suitable source and/or may be stored in the control information 122. The translated native format control information (non-CEC format control information) is then communicated from the CEC proxy device 102 to the television 148 via the IR blaster system 118.

In another operating example, the printer 144 may be of a type that is not HDMI enabled (and therefore, not CEC enabled). Here, the example printer 144 is illustrated as being communicatively coupled to the personal computer 126 via a USB connector 146. The personal computer 126 is configured to provide printable media and printing instructions to the printer 144 via the USB connector 146.

In an example scenario where the user wishes to print media using the printer 144, the user may actuate one of the controllers 160 on the remote control 104 that selects the personal computer 126 as the intended target electronic device. Accordingly, subsequent actuation of controllers generates control information intended to control the personal computer 126. For example, the controllers 164 may be used to generate up, down, right or left instructions or commands that move a pointer 166 about the display of the personal computer 126 so as to select or highlight a print button 168 presented on a print option screen 170. Then, the user may actuate the remote control 104 to select the print button 168, thereby causing the printer 144 to print the media.

In the above example of controlling the personal computer 126, the CEC proxy device 102 generates the control information in its own native format or another selected format. The processor system 114, executing the CEC proxy module 120, translates the control information received from the remote control 104 into corresponding CEC format control information for the personal computer 126. The translation is based on a-priori information about the CEC format that can be interpreted by the personal computer 126. Information pertaining to the format that can be interpreted by the personal computer 126 may be obtained from any suitable source and/or may be stored in the control information 122. The translated CEC format control information is then communicated from the CEC proxy device 102 to the personal computer 126 via its respective HDMI connector 106.

In yet another operating example, a generic non-HDMI enabled target electronic device 154 (which is also non-CEC enabled) may be operated by the remote control 104. Here, the example generic non-HDMI enabled target electronic device 154 is communicatively coupled to the CEC proxy device 102 via the wire-based connector 156. Alternatively, or additionally, the non-HDMI enabled target electronic device 154 may include a wireless radio frequency (RF) or IR receiver (not shown). Examples of generic non-HDMI enabled target electronic devices 154 include home appliances, such as refrigerators, stoves, telephones, security systems, lighting systems, or the like. Thus, the user may operate their remote control 104 to control various generic non-HDMI enabled target electronic devices 154.

In a first example scenario, the remote control 104 generates the control information using its own native format or another selected format. The CEC proxy device 102 translates the control information received from the remote control 104 into corresponding translated non-CEC format control information having the instructions or commands for the generic non-HDMI enabled target electronic device 154 based on a-priori information about the generic non-HDMI enabled target electronic device 154. Information pertaining to the formats that can be interpreted by the generic non-HDMI enabled target electronic device 154 may be obtained from any suitable source and/or may be stored in the control information 122. The control information signal is then communicated from the CEC proxy device 102 to the generic non-HDMI enabled target electronic device 154 via the wire-based connector 156, via the IR Blaster system 118, and/or via a RF transmitter (not shown).

The above-described operating examples demonstrate that the CEC proxy device 102 may be configured to translate control information having the instructions or commands generated by the remote control 104 for a variety of HDMI enabled target electronic devices, non-CEC enabled target electronic devices, or non-HDMI enabled target electronic devices. In some communication environments 124, a plurality of CEC proxy devices 102 may be used, wherein each of the CEC proxy devices 102 are configured to translate wireless signals emitted by the remote control 104. If duplicate and/or conflicting translated control information is communicated from a plurality of CEC proxy devices 102 over the HDMI system 142, collision protocols are available to manage flow of the communicated translated control information to the designated target electronic devices.

Further, embodiments of the CEC proxy device 102 may be configured to translate the control information generated by another remote control 172 that is different from the above-described remote control 104. Control information received from the remote control 172 may be translated to control any type of HDMI enabled target electronic device, non-CEC enabled target electronic device, or non-HDMI enabled target electronic device. The remote control 172 generates the control information using a non-CEC type format, such as its own native format or another selected format. The CEC proxy device 102 receives the transmitted wireless signal 174 from the remote control 172, and then translates the received control information into corresponding native format instructions or commands for the particular target electronic device. The translated control information is then communicated from the CEC proxy device 102 over HDMI connectors 106 to HDMI enabled target electronic devices, over other wire-based connectors to a connected target electronic device, and/or over the IR blaster system 118.

In alternative embodiments, the IR blaster system 118 is external to CEC proxy device 102. The external IR blaster system 118 may be communicatively coupled to one or more embodiments of the CEC proxy device 102. The translated non-CEC format control information is communicated from the CEC proxy device 102 to the IR blaster system 118, which then communicates the translated non-CEC format control information to the selected target electronic device via the wireless signal 118a.

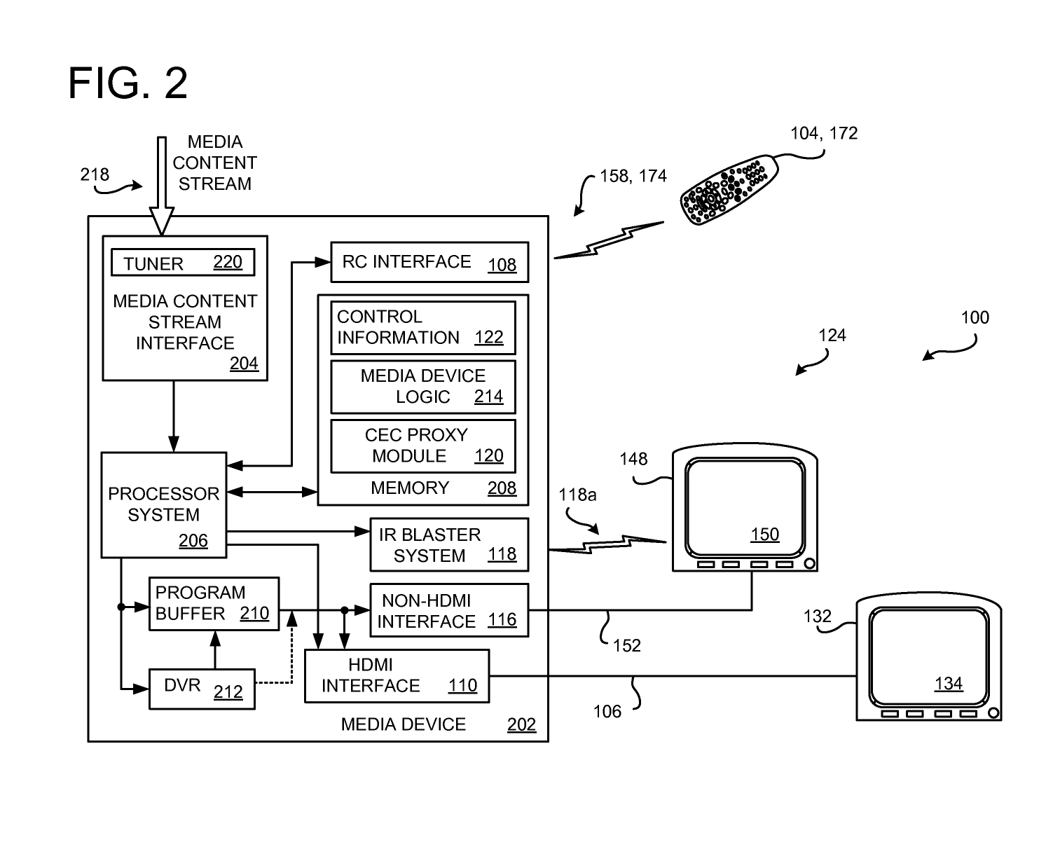

FIG. 2 is a block diagram of an embodiment of a remote control communication proxy system 100 implemented in a media device 202. The exemplary media device 202 is communicatively coupled to the example HDMI enabled television 132 via the HDMI connector 106. Alternatively, or additionally, the exemplary media device 202 is communicatively coupled to the example non-HDMI enabled television 148 via the example coaxial cable 152. Other types of media output devices may also be coupled to the media device 202, including those providing any sort of stimuli sensible by a human being, such as temperature, vibration and the like.

The non-limiting exemplary media device 202 comprises a media content stream interface 204, a processor system 206, a memory 208, a program buffer 210, an optional digital video recorder (DVR) 212, an optional HDMI interface 110, an optional non-HDMI interface 116, a remote control (RC) interface 108, and an optional IR blaster system 118. The memory 208 comprises portions for storing the media device logic 214, the CEC proxy module 120, and a control information 122. In some embodiments, the media device logic 214 and the CEC proxy module 120 may be integrated together, and/or may be integrated with other logic. In other embodiments, some or all of these memory and other data manipulation functions may be provided by and using remote server or other electronic devices suitably connected via the Internet or otherwise to a client device. Other media devices may include some, or may omit some, of the above-described media processing components. Further, additional components not described herein may be included in alternative embodiments.

The functionality of the media device 202, here a set top box, is now broadly described. A media content provider provides media content that is received in one or more multiple media content streams 218 multiplexed together in one or more transport channels. The transport channels with the media content streams 218 are communicated to the media device 202 from a media system sourced from a remote head end facility (not shown) operated by the media content provider. Non-limiting examples of such media systems include satellite systems, cable system, and the Internet. For example, if the media content provider provides programming via a satellite-based communication system, the media device 202 is configured to receive one or more broadcasted satellite signals detected by an antenna (not shown). Alternatively, or additionally, the media content streams 218 can be received from one or more different sources, such as, but not limited to, a cable system, a radio frequency (RF) communication system, or the Internet.

The one or more media content streams 218 are received by the media content stream interface 204. One or more tuners 220 in the media content stream interface 204 selectively tune to one of the media content streams 218 in accordance with instructions received from the processor system 206. The processor system 206, executing the media device logic 214 and based upon a request for a media content event of interest specified by a user, parses out media content associated with the media content event of interest. The media content event of interest is then assembled into a stream of video and/or audio information which may be stored by the program buffer 210 such that the media content can be streamed out to the televisions 132 and/or 148. Alternatively, or additionally, the parsed out media content may be saved into the DVR 212 for later presentation. The DVR 212 may be directly provided in, locally connected to, or remotely connected to, the media device 202.

The exemplary media device 202 is configured to receive commands from a user via the remote controls 104 or 172. The received wireless signal 158, 174 controls the media device 202 and/or may control the selected speakers 130.

The processes performed by the media device 202 relating to the processing of the received media content stream 218 and communication of a presentable media content event to the televisions 132 and/or 148, or other media presentation devices (not shown), are generally implemented by the processor system 206 executing the media device logic 214. Thus, the media device 202 may perform a variety of functions related to the processing and presentation of one or more media content events received in the media content streams 218.

When operating as a CEC proxy device, the media device 202 is configured to translate the control information in wireless signals received from one or more of the remote controls 104 or 172. Instructions or commands in the received wireless signals are translated by the media device 202 into a format that can be interpreted by the selected target electronic device. The translated control information is then communicated to the selected target electronic device via one or more of the HDMI connectors 106, via another connector such as the example coaxial cable 152, via the wireless signal 118a emitted by the IR Blaster system 118, and/or via a RF transmitter (not shown).

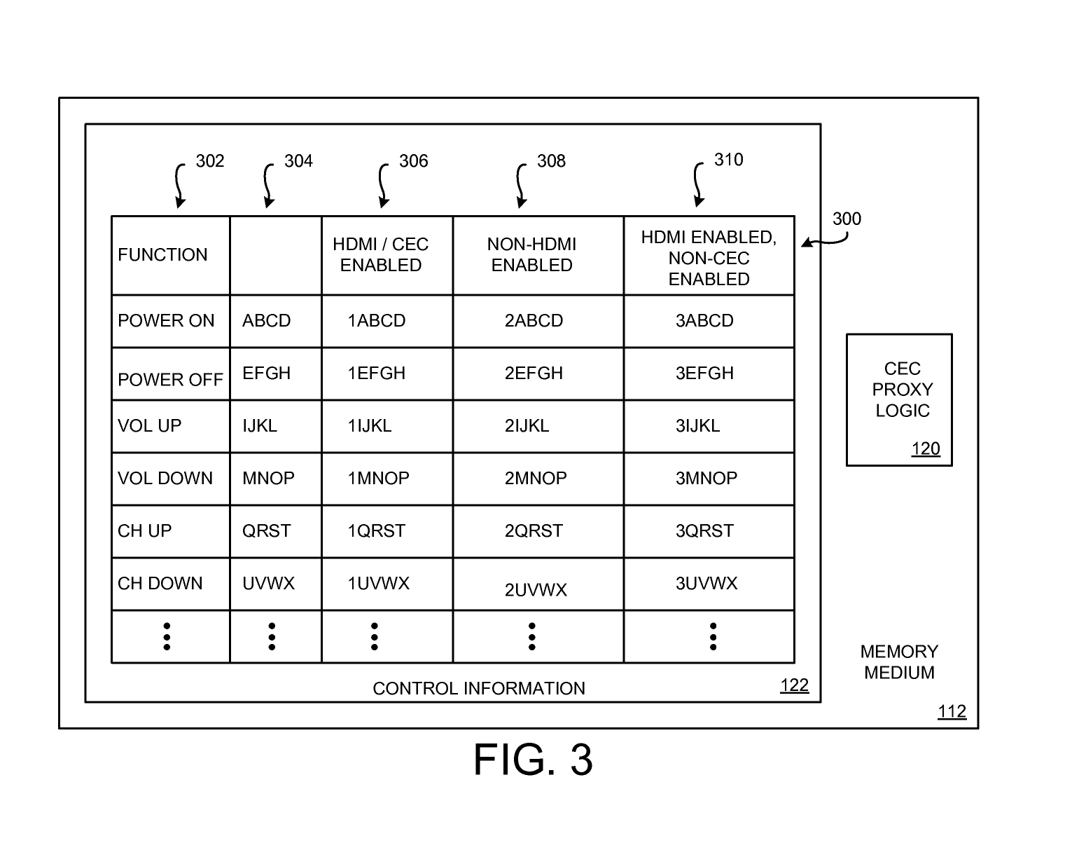

FIG. 3 conceptually illustrates a non-limiting example of information stored in the control information 122 region of the memory medium 112. The example control information 122 is illustrated in the form of a table 300. Other embodiments may configure the data residing in the control information 122 in any suitable format. Further, the control information 122 is conceptually illustrated as residing in the memory medium 112. In alternative embodiments, the control information 122 may be stored in a different memory medium.

The control information 122 optionally includes functional description information that describes the control operation to be performed by a particular target electronic device. The functional description information describes the meaning of a particular device control function. Example functions include, but are not limited to, power on, power off, volume (VOL) up, volume down, channel (CH) up and channel down are illustrated in the table 300. Many different functions associated with intended user commands and or instructions may be include in the table 300.

Control information for particular commands for the remote control 104 resides in a tabular column 304. For example, the control information (code) “ABCD” symbolically and conceptually corresponds to the “power on” command received from the remote control 104. In some embodiments, multiple tabular columns provide control information for a plurality of different remote controls, and/or for different command formats used by a universal type remote control.

The control information 122 further includes “codes” (specific machine readable commands that are configured to cause an operation of an electronic device) for the various types of controllable target electronic devices. For simplicity, three types of selectable target electronic device are indicated in table 300: a HDMI/CEC enabled device (with associated codes shown in column 306), a non-HDMI enabled device (with associated codes shown in column 308), and a HDMI enabled and non-CEC enabled device (with associated codes shown in column 310), which are symbolically and conceptually shown using alpha-numeric characters. The actual codes used may be generic codes so as to be interpreted by a plurality of target electronic devices, or may be device specific codes applicable to a particular target electronic device.

For example, codes for a target HDMI/CEC enabled type device would respond to translated CEC format control information generated using the control information 122 that uses the generic and standardized CEC format codes, which are symbolically and conceptually shown in column 306 using generic alpha-numeric characters. If the selected target electronic device of interest is a non-HDMI enabled type device, then the codes shown in column 308 may be specific to that particular target electronic device. In some applications, the codes of columns 308 and 310 may be the same since HDMI enabled, non-CEC enabled type devices and non-HDMI enabled type devices will not interpret CEC format control information. Further, multiple columns 306, 308, and/or 310 may be provided for different types of target electronic devices, such as when made by different manufacturers and/or are different models.

To conceptually describe various operating scenarios, the remote control 104 was described as having a controller 162 that is associated with a “power on” or a “power off” command. When the user actuates the controller 162, and when a particular controllable target electronic device has been selected, the remote control 104 then generates control information (which is symbolically shown as “ABCD”) that includes instructions or commands that that can be interpreted by the CEC proxy device 102.

In operating situations where the target electronic device is a non-HDMI enabled type device (and thus cannot receive CEC type signals), embodiments of the CEC proxy device 102 are configured to receive the wireless signal 158 communicated from the remote control 104, and translate (by mapping) the control information of tabular column 304 into a native format control information having instructions or commands that can be interpreted by the selected target electronic device.

For example, if the received wireless signal 158 is intended to power on a HDMI and CEC enabled target electronic device, the CEC proxy device 102 translates the “power on” code in the received wireless signal 158 (“ABCD”) to the code “1ABCD” and communicates it to the target electronic device (a HDMI/CEC enabled device). The “1ABCD” code may be communicated via the HDMI connector 106. In response, the target electronic device is then operated to power itself on.

Similarly, if the received wireless signal 158 is intended to power on a non-HDMI enabled target electronic device, the CEC proxy device 102 translates the power on code in the received wireless signal 158 to the code “2ABCD” and communicates it to the target electronic device (a non-HDMI enabled device). The “2ABCD” code may be communicated via the IR blaster system 118, via a suitable connector, and/or via a RF transmitter (not shown). In response, the target electronic device is then operated to power itself on.

Further, if the selected target electronic device is a HDMI enabled and non-CEC enabled type device, (and thus cannot receive CEC type signals over its HDMI connector 106), embodiments of the CEC proxy device 102 are configured to receive the wireless signal 158 communicated from the remote control 104, and translate the control information using the code “3ABCD” of column 310. The “3ABCD” code (non-CEC format control information) may be communicated to the target electronic device via the HDMI connector 106.

In the various embodiments, higher level features under the CEC format may be implemented in the CEC proxy device 102. Such higher order features may include one or a plurality of communicated commands (CEC format control information) communicated to the target electronic device and one or more acknowledgements received by the CEC proxy device 102 from the target electronic device and/or other HDMI connected electronic devices. In some embodiments, the CEC proxy device 102 may also, as a part of this higher level feature, send non-CEC commands to other connected devices which it determines would not receive the command in CEC format. For example, an operating parameter of a non-CEC enabled electronic device may concurrently be controlled as part of a higher functioning process.

For example, a system standby command may be transmitted from the remote control 104 that is intended to place all active devices in a standby mode, a power down mode, a power off mode, or the like. Thus, the CEC proxy device 102 may need to first send a CEC format standby command (directly or broadcast) to place into standby those devices which will respond to the CEC format standby command. The CEC proxy device 102 may then need to issue specific standby commands for the other, non-CEC, target electronic devices (which may each have different standby commands that are transmitted over the HDMI connector 106 and/or the IR blaster system 118.)

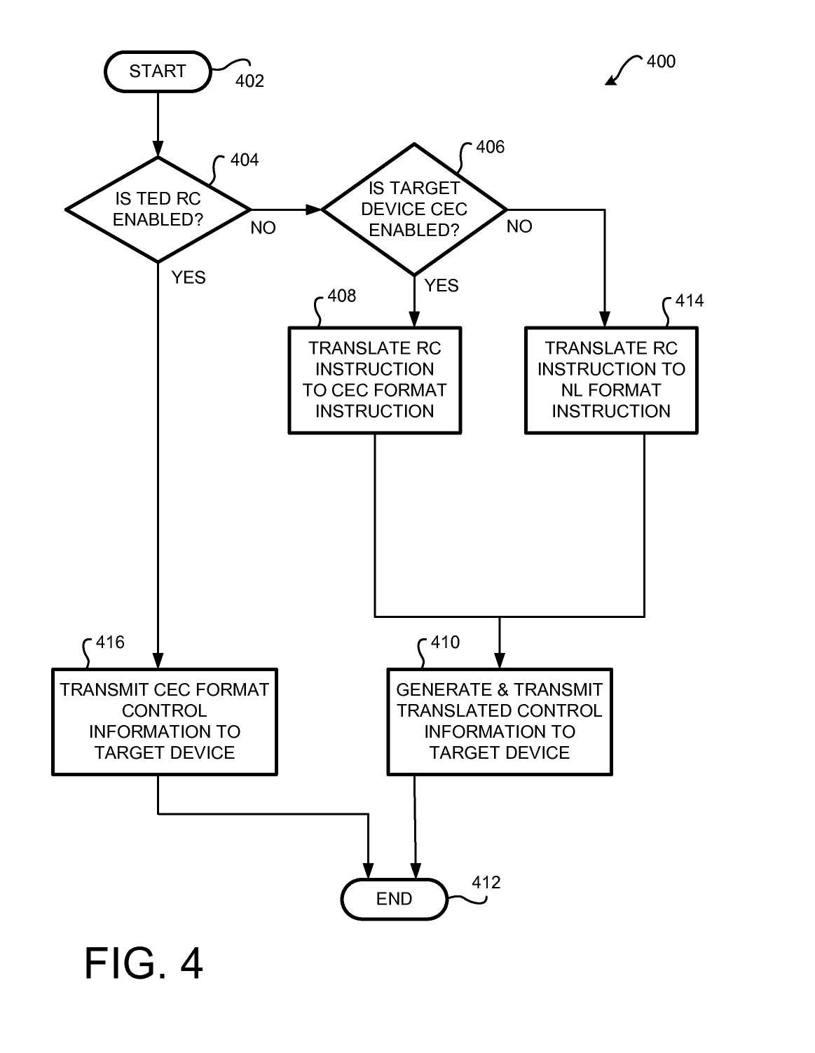

FIG. 4 is an example flow chart 400 conceptually illustrating operation of an embodiment of the CEC proxy device 102. The flowchart 400 shows the architecture, functionality, and operation of a possible implementation of the software for implementing the CEC proxy module 120. In this regard, each block may represent a module, segment, or portion of code, which comprises one or more executable instructions for implementing the specified logical function(s). It should also be noted that in some alternative implementations, the functions noted in the blocks may occur out of the order noted in FIG. 4, may include additional functions, and/or may omit some functions. For example, two blocks shown in succession in FIG. 4 may in fact be executed substantially concurrently, the blocks may sometimes be executed in the reverse order, or some of the blocks may not be executed in all instances, depending upon the functionality involved. All such modifications and variations are intended to be included herein within the scope of this disclosure.

With respect to FIG. 4, the process starts at block 402, for example, in response to communication of the wireless signal 158 from the remote control 104. At block 404, a determination is made whether the target electronic device (TED) is enabled to received control information from the remote control 104 (RC). If the target electronic device is not configured to receive and/or respond to the control commands from the remote control 104 (the NO condition), the process proceeds to block 406 where a determination is made if the target electronic device is CEC enabled.

If at block 406 the target electronic device is CEC enabled (the YES condition), the control information in the wireless signal 158 received from the remote control 104 is translated to a CEC format control information at block 408. The translated CEC format control information is generated and communicated to the target electronic device at block 410, preferably via the HDMI connector 106 that is connected to the target electronic device. The process then ends at block 412 and awaits the next wireless signal 158 from the remote control 104 or a different remote control.

Returning to the description of block 406, if the target electronic device is not CEC enabled (the NO condition), the information in the wireless signal 158 received from the remote control 104 is translated to a native language (NL) format instruction that can be interpreted by the selected target electronic device at block 414. The translated native language non-CEC format control information is generated and communicated to the target electronic device at block 410. In some embodiments, the control information is generated and communicated by the CEC proxy device 102 to the target electronic device via the HDMI connector 106 that is connected to the target electronic device. Alternatively, or additionally, the translated control information may be communicated via a wireless signal. The process then ends at block 412 and awaits the next wireless signal 158 from the remote control 104 or a different remote control.

Returning to the description of block 404, if the target electronic device is configured to received control information from the remote control 104 (the YES condition), the process proceeds to block 416 where the control information is communicated directly to the target electronic device, preferably via a wireless signal. The process then ends at block 412 and awaits the next wireless signal 158 from the remote control 104 or a different remote control.

Some embodiments may be additionally configured to, or alternatively configured to, communicate Mobile High-Definition Link (MHL) format commands using an MHL-based proxy device 102. Here, the interface 110 is configured to connect to one or more MHL connectors to a MHL enabled electronic device. MHL is an industry standard for a mobile audio/video interface for directly connecting mobile phones and other portable consumer electronics (CE) devices to high-definition televisions (HDTVs) and displays. The MHL standard features a single cable with a low pin-count interface able to support up to 1080p high-definition (HD) video and digital audio while simultaneously charging the connected device. Accordingly, the MHL proxy device 102 is configured to receive commands for the remote control 104, generate MHL format commands, and then communicate the MHL format commands to a MHL enabled target electronic device via a MHL wire-based connector. Example MHL formats are defined in various MHL specification documents. For example, but not limited to, the MHL Specification v. 1.0, available on Apr. 14, 2010, specifies MHL formats, which is incorporated by reference herein in its entirety.

It should be emphasized that the above-described embodiments of the remote control communication proxy system 100 are merely possible examples of implementations of the invention. Many variations and modifications may be made to the above-described embodiments. All such modifications and variations are intended to be included herein within the scope of this disclosure and protected by the following claims.

1. A method, comprising:
receiving control information via a wireless signal from a remote control, the control information configured to control operation of a target electronic device;
determining whether the target electronic device is configured to receive Consumer Electronic Control (CEC) format control information or receive non-CEC format control information;
in response to determining that the target electronic device is configured to receive CEC format control information, the method further comprising:
translating the received control information into CEC format control information that the target electronic device is configured to interpret; and
communicating the translated CEC format control information to the target electronic device over a high-definition multimedia (HDMI) connector using a CEC format; and
in response to determining that the target electronic device is not configured to receive CEC format control information, the method further comprising:
translating the received control information into translated control information that the target electronic device is configured to interpret; and
communicating the translated control information to the target electronic device.

2. The method of claim 1, where in response to determining that the target electronic device is not configured to receive CEC format control information, and wherein the target electronic device is configured to communicate over the HDMI connector, the method further comprising:
communicating the translated control information to the target electronic device over the HDMI connector.

3. The method of claim 1, wherein the wireless signal received from the remote control is a first wireless signal, and where in response to determining that the target electronic device is not configured to receive CEC format control information, the method further comprising:
communicating the translated control information to the target electronic device using a second wireless signal.

4. The method of claim 3, wherein communicating the translated control information to the target electronic device using the second wireless signal comprises:
communicating the translated control information in the second wireless signal from an infrared (IR) blaster system.

5. The method of claim 3, wherein communicating the translated control information to the target electronic device using the second wireless signal comprises:
communicating the translated control information in the second wireless signal from a radio frequency (RF) system.

6. The method of claim 1, wherein translating the received control information into translated control information that the target electronic device is configured to interpret further comprises:
determining a native language format that the target electronic device is configured to interpret; and
translating the received control information into translated control information using the native language format.

7. The method of claim 1, wherein determining whether the target electronic device is configured to receive Consumer Electronic Control (CEC) format control information or receive non-CEC format control information further comprises:
communicating a query onto a HDMI system to which a plurality of HDMI electronic devices are coupled to; and
receiving a response via the HDMI system to at least one active one of the HDMI electronic devices,
wherein the target electronic device is identified based on the response received via the HDMI system.

8. The method of claim 1, wherein the wireless signal received from the remote control is associated with a higher level feature defined under the CEC format, and further comprising:
communicating first CEC format control information to the target electronic device;
receiving an acknowledgement from the target electronic device; and
communicating second CEC format control information to the target electronic device.

9. The method of claim 1, wherein the target electronic device is a first target electronic device, wherein the HDMI connector is a first HDMI connector, and the method further comprising:
determining that a second target electronic device is configured to receive CEC format control information;
translating the received control information into CEC format control information that the second target electronic device is configured to interpret; and
communicating the translated CEC format control information to the second target electronic device over a second HDMI connector.

10. A system, comprising:
a remote control interface configured to receive a wireless signal with control information from a remote control, the control information configured to control operation of a target electronic device;
a memory configured to store logic that determines whether the target electronic device is configured to receive Consumer Electronic Control (CEC) format control information; and
a processor system communicatively coupled to the remote control interface and the memory, wherein the processor system is configured to determine whether the target electronic device is configured to receive CEC format control information,
where in response to determining that the target electronic device is configured to receive CEC format control information, the processor system is further configured to translate the received control information into translated control information in a CEC format that the target electronic device is configured to interpret, and to communicate the translated control information in the CEC format to the target electronic device over a high-definition multimedia (HDMI) connector, and
where in response to determining that the target electronic device is not configured to receive CEC format control information, the processor system is further configured to translate the received control information into translated control information that the target electronic device is configured to interpret, and to communicate the translated control information to the target electronic device.

11. The system of claim 10, further comprising:
an HDMI interface communicatively coupled to the processor system and configured to couple to the HDMI connector connected to the target electronic device, wherein the HDMI interface communicates the translated control information to the target electronic device over the HDMI connector using the CEC format in response to determining that the target electronic device is configured to receive CEC format control information.

12. The system of claim 10, further comprising:
an HDMI interface communicatively coupled to the processor system and configured to couple to the HDMI connector connected to the target electronic device, wherein the HDMI interface communicates the translated control information to the target electronic device over the HDMI connector using a non-CEC format in response to determining that the target electronic device is not configured to receive CEC format control information.

13. The system of claim 10, further comprising:
an infrared (IR) blaster communicatively coupled to the processor system, wherein the IR blaster communicates the translated control information in an IR signal to the target electronic device in response to determining that the target electronic device is not configured to receive CEC format control information.

14. The system of claim 10, further comprising:
a non-HDMI device interface communicatively coupled to the processor system and configured to couple to a wire-based connector that is coupled to the target electronic device, wherein the non-HDMI device interface communicates translated control information to the target electronic device in response to determining that the target electronic device is not configured to receive CEC format control information.

15. A method, comprising:
determining whether a target electronic device is configured to receive one of Consumer Electronic Control (CEC) control information and Mobile High-Definition Link (MHL) control information, wherein the control information is configured to control operation of the target electronic device;
in response to determining that the target electronic device is configured to receive the control information, the method further comprising:
translating the control information into CEC translated control information using a CEC format when the target electronic device is a CEC enabled electronic device;
translating the control information into Mobile High-Definition Link (MHL) translated control information when the target electronic device is a MHL enabled electronic device;
communicating the CEC translated control information to the target electronic device over a high-definition multimedia (HDMI) connector using the CEC translated control information when the target electronic device is the CEC enabled electronic device;
communicating the MHL translated control information to the target electronic device over a MHL connector when the target electronic device is the MHL enabled electronic device; and
in response to determining that the target electronic device is not configured to receive CEC control information, the method further comprising:
translating the control information into second translated control information that the target electronic device is configured to interpret; and
communicating the second translated control information to the target electronic device.

16. The method of claim 15, further comprising:
receiving the control information in a wireless signal transmitted by a remote control.

17. The method of claim 15, wherein communicating the second translated control information to the target electronic device comprises:
communicating the second translated control information to the target electronic device over the HDMI connector.

18. The method of claim 15, wherein communicating the second translated control information to the target electronic device comprises:
communicating the second translated control information to the target electronic device using an infrared signal.

19. The method of claim 15, wherein communicating the second translated control information to the target electronic device comprises:
communicating the second translated control information to the target electronic device using a radio frequency (RF) signal.

20. The method of claim 15, where in response to determining that the target electronic device is configured to receive CEC format control information, the method further comprises:
communicating a query onto a HDMI system to which a plurality of HDMI electronic devices are coupled to; and
receiving a response via the HDMI system to at least one active one of the HDMI electronic devices,
wherein the target electronic device is identified based on the response received via the HDMI system.
